(19) United States
(12) Patent Application Publication
(10) Pub. No.: US 2023/0395928 A1
(43) Pub. Date: Dec. 7, 2023

(54) STORAGE BATTERY CONNECTION MODULE, WIRE HARNESS, AND POWER STORAGE SYSTEM

(71) Applicant: YAZAKI CORPORATION, Tokyo (JP)

(72) Inventors: Chihiro Ono, Susono-shi (JP); Takahiro Syouda, Susono-shi (JP)

(21) Appl. No.: 18/329,574

(22) Filed: Jun. 5, 2023

(30) Foreign Application Priority Data
Jun. 7, 2022 (JP) 2022-102842

(51) Int. Cl. H01M 50/298; H01B 7/00; H01M 50/209; H01M 50/51; H01M 10/54; H01M 10/42

(52) U.S. Cl. CPC H01M 50/298; H01B 7/0045; H01M 50/209; H01M 50/51; H01M 10/54; H01M 10/425; H01M 2010/4271

(57) ABSTRACT

A storage battery connection module in which a plurality of storage battery modules are connected in series is provided. The storage battery connection module includes a base plate, a plurality of connection terminals provided on the base plate, a plurality of wire harnesses each connecting the connection terminal to a positive and negative electrode terminals of the storage battery module, and a plurality of bus bars provided on the base plate and connecting the plurality of the connection terminals in series.

### CROSS-REFERENCE TO RELATED APPLICATIONS

This application is based on and claims priority under 35 USC 119 from Japanese Patent Application No. 2022-102842 filed on Jun. 27, 2022, the contents of which are incorporated herein by reference.

### TECHNICAL FIELD

The present invention relates to a storage battery connection module, a wire harness, and a power storage system.

### BACKGROUND ART

As a power storage system in which a plurality of storage batteries are connected in series, there is known a power storage system including a switch that connects or blocks the storage batteries, a switch that connects or blocks a bypass line that bypasses the storage batteries, and a control device that detects a state of the storage batteries and controls both the switches according to the detected state (for example, refer to Patent Literatures 1 to 3).

### CITATION LIST

### Patent Literature

Patent Literature 1: JP2013-31247A
Patent Literature 2: JP2013-31249A
Patent Literature 3: JP2020-171164A

### SUMMARY OF INVENTION

When the above-described power storage system is constituted by connecting a large number of storage batteries in series, a large number of power lines and signal lines and a large amount of wiring work and wiring connection work are required. Therefore, as the number of connections of the storage batteries increases, the number of assembly steps of the power storage system increases, and work becomes complicated.

In view of the above circumstances, an object of the present invention is to provide a storage battery connection module, a wire harness, and a power storage system that can prevent an increase in the number of assembly steps of connecting a plurality of storage batteries in series and complicated work.

A storage battery connection module of the present invention connects storage battery connection module in series. The storage battery connection module includes a base plate constituted by a plurality of insulating plates which are integrated or one long insulating plate, a plurality of first connection terminals provided on the base plate, a plurality of first power lines each connecting the first connection terminal to a positive electrode terminal and a negative electrode terminal of the storage battery, and a second power line provided on the base plate and connecting the plurality of first connection terminals in series.

A wire harness of the present invention is used in a storage battery connection module in which a plurality of recycled storage batteries are connected in series. The storage battery connection module includes a base plate constituted by a plurality of insulating plates which are integrated or one long insulating plate, a plurality of connection terminals provided on the base plate, and a power line provided on the base plate and connecting the plurality of connection terminals in series. The wire harness connects the connection terminal to a positive electrode terminal and a negative electrode terminal of the storage battery, and is a dedicated product which is exclusively manufactured for each type of the storage battery.

A power storage system includes a plurality of storage batteries, and a storage battery connection module in which the plurality of storage batteries are connected in series. The storage battery connection module includes a base plate constituted by a plurality of insulating plates which are integrated or one long insulating plate, a plurality of connection terminals provided on the base plate, a plurality of first power lines each connecting the connection terminal to a positive electrode terminal and a negative electrode terminal of the storage battery, and a second power line provided on the base plate and connecting the plurality of connection terminals in series.

According to the present invention, it is possible to prevent an increase in the number of assembly steps of connecting a plurality of storage batteries in series, and complicated work.

### BRIEF DESCRIPTION OF DRAWINGS

FIG. 1 is a perspective view showing a power storage system including a storage battery connection module according to an embodiment of the present invention;

FIG. 2 is a plan view showing the power storage system shown in FIG. 1;

FIG. 3 is a circuit diagram showing the power storage system shown in FIGS. 1 and 2;

FIG. 4 is a circuit diagram showing a modification of the power storage system shown in FIG. 3;

FIG. 5 is a plan view showing a connection unit shown in FIGS. 1 and 2;

FIG. 6 is a plan view showing a connection unit shown in FIGS. 1 and 2;

FIG. 7 is a plan view showing a connection unit shown in FIGS. 1 and 2; and

FIG. 8 is a plan view showing a power storage system including a storage battery connection module according to another embodiment of the present invention.

### DESCRIPTION OF EMBODIMENTS

The present invention will be described below in accordance with a preferred embodiment. Also, it should be noted that the present invention is not limited to the embodiment to be illustrated below, and the embodiment can be appropriately modified without departing from the gist of the present invention. In addition, in the embodiment illustrated below, illustration and description of some configurations are omitted, but regarding details of the omitted techniques, publicly known or well-known techniques are appropriately applied as long as there is no contradiction with the contents described below.

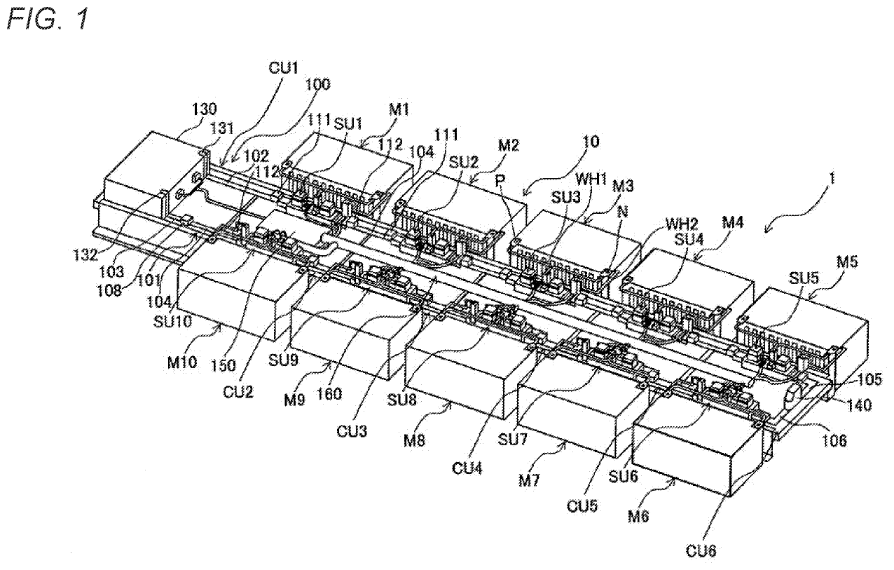

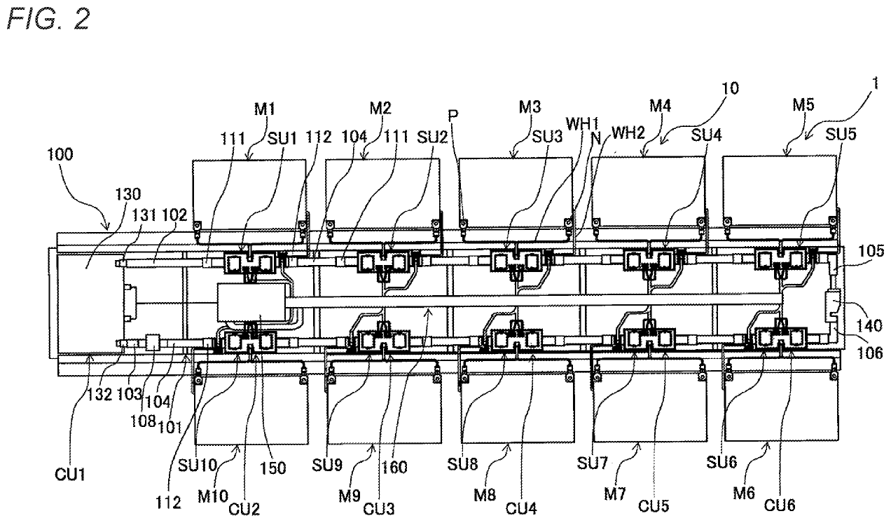

FIG. 1 is a perspective view showing a power storage system 1 including a storage battery connection module 100 according to an embodiment of the present invention. FIG. 2 is a plan view showing the power storage system 1 shown in FIG. 1. As shown in these drawings, the power storage system 1 includes a storage battery string 10 and the storage battery connection module 100.

The storage battery string 10 is a stationary or in-vehicle power supply including n (n represents an integer of 2 or more, and is 10 in the present embodiment) storage battery modules M1 to M10 connected in series. Although not particularly limited, the storage battery string 10 according to the present embodiment is obtained by recycling used storage batteries, and the storage battery modules M1 to M10 differ in a degree of deterioration. The storage battery modules M1 to M10 are secondary batteries such as a lithium ion battery and a lithium ion capacitor, are charged by being supplied with power from an external system (not shown) through a power converter 130, and discharge the charged power through the power converter 130 to supply power to the external system.

The external system includes a load, a generator, and the like. When the power storage system 1 is a stationary power storage system, home appliances, commercial power supply systems, liquid crystal displays, communication modules and the like serve as loads, and a solar photovoltaic power generation system or the like serves as a generator. On the other hand, when the power storage system 1 is used in a vehicle, a drive motor, an air conditioner, various in-vehicle electrical components, and the like serve as the load. The drive motor serves as the load and also as the generator.

The storage battery string 10 may include a plurality of storage battery cells or storage battery packs connected in series, instead of the plurality of storage battery modules M1 to M10 connected in series. Further, as will be described later, the power storage system 1 includes a bypass circuit that bypasses each of the storage battery modules M1 to M10, and may include a bypass circuit that bypasses each of the storage battery cells or each of the storage battery packs.

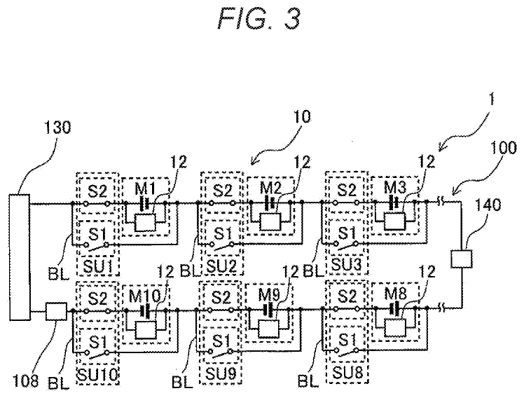

The storage battery string 10 includes a plurality of voltage sensors 12 (see FIG. 3 and the like). The voltage sensor 12 is connected between a positive electrode terminal P and a negative electrode terminal N of each of the storage battery modules M1 to M10. The voltage sensor 12 measures an inter-terminal voltage of each of the storage battery modules M1 to M10.

The storage battery modules M1 to M10 each include the positive electrode terminal P and the negative electrode terminal N to which a wire harness WH1 for power supply is connected. Positions, sizes, and shapes of the positive electrode terminal P and the negative electrode terminal N are different for each product. For example, when in-vehicle storage battery modules are recycled, the positions, sizes, and shapes of the positive electrode terminal P and the negative electrode terminal N are different for each vehicle type.

The storage battery modules M1 to M10 include terminals (not shown) to which wire harnesses WH2 for communication and power supply are connected. Positions, sizes, and shapes of the terminals and the number, positions, and thicknesses of pins are different for each product. For example, when the in-vehicle storage battery modules are recycled, the positions, sizes, and shapes of the terminals and the number, positions, and thicknesses of the pins are different for each vehicle type.

A type of information output from the storage battery modules M1 to M10 through the wire harness WH2 for communication is different for each product. For example, when the in-vehicle storage battery modules are recycled, the type of the information output through the wire harness WH2 for communication is different for each vehicle type. As the information output from the storage battery modules M1 to M10 through the wire harness WH2 for communication, the inter-terminal voltage of each of the storage battery modules M1 to M10 measured by the voltage sensor 12, temperature information in a case where a temperature sensor is mounted on each of the storage battery modules M1 to M10, abnormality detection information in a case where a cell management unit (CMU) is mounted on each of the storage battery modules M1 to M10, and the like can be exemplified.

The storage battery connection module 100 includes a base plate 101, a plurality of switch units SU1 to SU10, and bus bars 102, 103, 104, 105, and 106. The storage battery connection module 100 includes a current sensor 108, the power converter 130, a service plug 140, and a battery management system (BMS) 150. The storage battery connection module 100 further includes a wire harness unit 160 for communication and power supply, the wire harnesses WH1 for power supply, and the wire harnesses WH2 for communication and power supply.

On the other hand, the storage battery connection module 100 includes n (n is an integer of 2 or more, and is 6 in the present embodiment) connection units CU1 to CU6 linearly disposed. The leading connection unit CU1 is provided with the power converter 130 and the current sensor 108. Following the connection unit CU1, the connection units CU2 to CU6 are disposed in order. The connection units CU3 to CU5 disposed between the connection unit CU2 and the last connection unit CU6 have the same configuration. Configurations of the connection units CU2 and CU6 are different from those of the connection units CU3 to CU5. Further, the configurations of the connection units CU2 and CU6 are different from each other. However, the connection units CU2 to CU6 include units having a common structure. The connection unit CU2 is manufactured by mounting the BMS 150 and the like on the unit having the common structure. The connection unit CU6 is manufactured by mounting the service plug 140, the bus bars 105 and 106, and the like on the unit having the common structure. Instead of the bus bars 102 to 106, another conductor through which a large amount of current can flow may be used.

The storage battery modules M1 to M5 are linearly disposed in a row from a head to a tail, and the storage battery modules M6 to M10 are linearly disposed in a row from the tail to the head. The row of the storage battery modules M1 to M5 and the row of the storage battery modules M6 to M10 are disposed in parallel to each other, and the storage battery connection module 100 is disposed therebetween. The storage battery connection module 100 may be disposed to overlap the storage battery modules M1 to M10.

The connection unit CU2 is disposed between the storage battery module M1 and the storage battery module M10, and includes a pair of switch units SU1 and SU10. The connection unit CU3 is disposed between the storage battery module M2 and the storage battery module M9, and includes a pair of switch units SU2 and SU9. The connection unit CU4 is disposed between the storage battery module M3 and the storage battery module M8, and includes a pair of switch units SU3 and SU8. The connection unit CU5 is disposed between the storage battery module M4 and the storage battery module M7, and includes a pair of switch units SU4 and SU7. The connection unit CU6 is disposed between the storage battery module M5 and the storage battery module M6, and includes a pair of switch units SU5 and SU6.

The storage battery modules M1 to M10 are disposed in order of M1, M2, - - - M10 in a connection direction of the storage battery modules M1 to M10, whereas the switch units SU1 to SU10 are disposed in order of SU1, SU2, - - - SU10 in the connection direction of the storage battery modules M1 to M10. The switch unit SU1 is connected to the positive electrode terminal P and the negative electrode terminal N of the storage battery module M1 by the wire harness WH1 for power supply, and is connected to a connection terminal (not shown) for communication and power supply of the storage battery module M1 by the wire harness WH2 for communication and power supply. Similarly, each of the switch units SU2 to SU10 is connected to the positive electrode terminal P and the negative electrode terminal N of each of the storage battery modules M2 to M10 by the wire harness WH1 for power supply, and is connected to the connection terminal for communication and power supply of each of the storage battery modules M2 to M10 by the wire harness WH2 for communication and power supply. The switch units SU1 to SU10 have the same configuration. The configuration of the switch units SU1 to SU10 will be described in detail later.

The power converter 130 is, for example, a bidirectional DC/DC converter, and includes a positive electrode terminal 131 on a primary side during discharge, a negative electrode terminal 132 on the primary side during discharge, a positive electrode terminal (not shown) on a secondary side during discharge, and a negative electrode terminal (not shown) on the secondary side during discharge. The positive electrode terminal 131 is connected to an input terminal 111 of the switch unit SU1 of the connection unit CU2 by the bus bar 102. The negative electrode terminal 132 is connected to the current sensor 108 by the bus bar 103. The current sensor 108 is connected to an output terminal 112 of the switch unit SU10 of the connection unit CU2 by the bus bar 104.

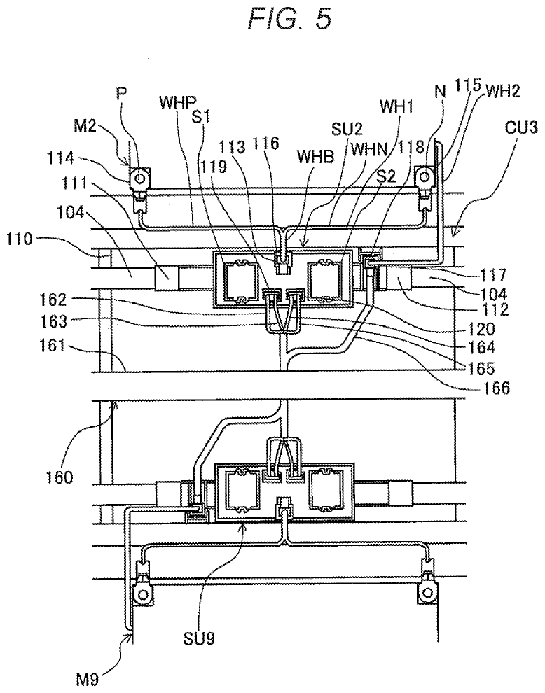

The output terminal 112 of the switch unit SU1 and the input terminal 111 of the switch unit SU2 are connected by the bus bar 104. Similarly, the switch units SU1 to SU5 adjacent in the connection direction of the storage battery modules M1 to M5 are electrically connected by the bus bar 104, and the switch units SU6 to SU10 adjacent in the connection direction of the storage battery modules M6 to M10 are electrically connected by the bus bar 104. Here, since the adjacent switch units SU1 to SU10 are mechanically coupled by the bus bar 104, the plurality of connection units CU2 to CU6 are integrated, and the base plate 101 in which a plurality of plates 110 (see FIG. 5 and the like) are integrated is formed.

FIG. 3 is a circuit diagram showing the power storage system 1 shown in FIGS. 1 and 2. As shown in this drawing, the power storage system 1 includes n (n is an integer of 2 or more, and is 10 in the present embodiment) bypass circuits provided for each of the storage battery modules M1 to M10. Each of the bypass circuits includes a bypass line BL and switches S1 and S2. The bypass line BL is a power line that bypasses each of the storage battery modules M1 to M10. The switch S1 is provided in the bypass line BL. The switch S1 is, for example, a mechanical switch. The switch S2 is provided between a positive electrode of each of the storage battery modules M1 to M10 and one end of the bypass line BL. The switch S2 is, for example, a semiconductor switch or a relay.

When the switches S1 are open and the switches S2 are closed in all the bypass circuits, all the storage battery modules M1 to M10 are connected in series to the power converter 130 and the external system (not shown). On the other hand, when the switches S2 are opened and the switches S1 are closed in any one of the bypass circuits, the storage battery modules M1 to M10 corresponding to the bypass circuits are bypassed.

The switches S1 and S2 are provided in the switch units SU1 to SU10 (see FIG. 1). The BMS 150 (see FIG. 1 and the like) is connected to the switch units SU1 to SU10, and the BMS 150 executes monitoring and control of the respective storage battery modules M1 to M10, switching control of the respective bypass circuits, and the like.

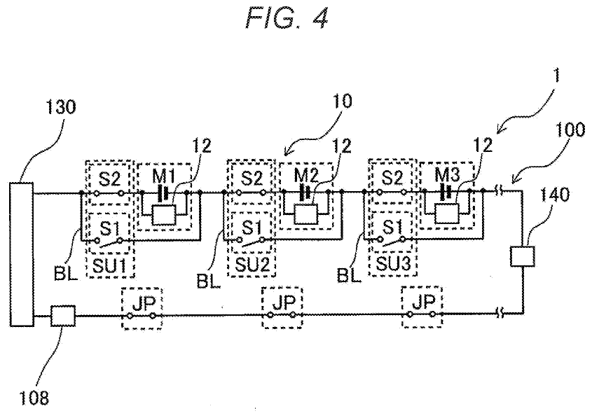

FIG. 4 is a circuit diagram showing a modification of the power storage system 1 shown in FIG. 3. As shown in FIGS. 3 and 4, in the power storage system 1, the number of connections of the storage battery modules M1 to M10 can be increased or decreased. Accordingly, regarding the connection units CU1 to CU10 (see FIG. 1 and the like) in which the number of connections of the storage battery modules M1 to M10 is 1 or 0, the switch units SU1 to SU10 may not be mounted, or at least one of the switches S1 and S2 may not be mounted on the switch units SU1 to SU10.

Here, a power line (not shown) and the bypass line BL are provided in the switch units SU1 to SU10. The power line connects the bus bar (104 or the like) provided on the plate 110 (see FIG. 5 and the like) described later and a connection terminal 113 (see FIG. 5). The power line is provided with the switch S2.

When the number of connections of the storage battery modules M1 to M10 to the connection units CU1 to CU10 is 1 or 0, the following measures (1) to (3) can be taken. (1) As shown in FIG. 4, the corresponding switch units SU1 to SU10 are not mounted, jumpers JP are attached to positions of the switch units SU1 to SU10 on the plate 110, and the bus bars (104 and the like) on a plate 110 side are connected by the jumpers JP. (2) The switches S1 are not mounted on the switch units SU1 to SU10, the jumpers JP are attached to positions of the switches S1 on the switch units SU1 to SU10, and the bypass line BL is connected by a jumper (not shown). The switches S2 may be mounted or not mounted. (3) The switches S2 are not mounted on the switch units SU1 to SU10, and jumpers (not shown) are attached to positions of the switches S2 and positions of the connection terminals 113 on the switch units SU1 to SU10 to connect the power lines on the switch units SU1 to SU10. The switches S1 may be mounted or not mounted.

On the other hand, in the power storage system 1, it is possible to not provide the bypass circuit or increase or decrease the number of bypass circuits. When the number of bypass circuits of the connection units CU1 to CU10 is 1 or 0, the following measures (4) to (6) can be taken. (4) The switch units SU1 to SU10 are replaced with jumper units (not shown) having a structure for connecting the storage battery modules M1 to M10 to the bus bars (104 and the like) on the plate 110 without including the bypass circuit. (5) The switch units SU1 to SU10 are not mounted, a connection terminal (not shown) is provided in place of the connection terminal 113, and a jumper (not shown) is attached between the connection terminal and the bus bar (104 or the like) on the plate 110 to connect the connection terminal and the bus bar (104 or the like). (6) The switches S2 are not mounted on the switch units SU1 to SU10, and jumpers (not shown) are attached to the positions of the switches S2 on the switch units SU1 to SU10 to connect the power lines on the switch units SU1 to SU10. The switches S1 may be mounted or not mounted.

FIG. 5 is a plan view showing the connection unit CU3 shown in FIGS. 1 and 2. The connection units CU4 and CU5 have the same configuration as the connection unit CU3. As shown in this drawing, the connection unit CU3 includes the plate 110 and the pair of switch units SU2 and SU9. The plate 110 is formed of an insulating plate material. Examples of the material of the plate 110 include resin and Bakelite.

Here, the plate 110 is a common component of the connection units CU2 to CU6, and the plates 110 of the connection units CU2 to CU6 have a common shape and a common dimension, and are formed of a common material. The plurality of plates 110 are disposed in a row to form the long base plate 101 (see FIG. 1 and the like).

The pair of switch units SU2 and SU9 are mounted on the plate 110 so as to face each other with the wire harness unit 160 for communication and power supply interposed therebetween. The switch unit SU2 faces the storage battery module M2, and the switch unit SU9 faces the storage battery module M9. The switch unit SU2 and the switch unit SU9 may be integrated.

The positive electrode terminals P and the negative electrode terminals N of the storage battery modules M1 to M10 are provided on upper faces of the storage battery modules M1 to M10 so as to be separated from each other in an arrangement direction (a left-right direction in the drawing) of the plurality of connection units CU1 to CU6. The wire harness WH1 for power supply includes a wiring WHP on a positive electrode side, a wiring WHN on a negative electrode side, and a bundle portion WHB in which both the wirings WHP and WHN are bundled. A connection terminal 114 connected to the positive electrode terminal P is provided at a tip end of the wiring WHP on the positive electrode side, and a connection terminal 115 connected to the negative electrode terminal N is provided at a tip end of the wiring WHN on the negative electrode side. A connection terminal 116 is provided at a base end of the bundle portion WHB. Accordingly, the connection terminals 113 are provided on upper faces of the switch units SU1 to SU10, and the connection terminals 116 of the wire harnesses WH1 for power supply are connected to the connection terminals 113. Further, connection terminals 118 are provided in the switch units SU1 to SU10, and connection terminals 117 of the wire harnesses WH2 for communication and power supply are connected to the connection terminals 118.

Here, the wire harness WH1 for power supply is a dedicated product provided for each type of the storage battery modules M1 to M10 to be connected. That is, configurations of the connection terminals 114 and 115 of the wire harness WH1 for power supply, a length and a thickness of the wire harness WH1 for power supply, and the like are set for each type of the storage battery modules M1 to M10 to be connected. The connection terminals 116 of the wire harnesses WH1 for power supply are standardized regardless of the types of the storage battery modules M1 to M10.

In addition, the wire harness WH2 for communication and power supply is a dedicated product provided for each type of the storage battery modules M1 to M10 to be connected. That is, a length and a thickness of the wire harness WH2 for communication and power supply, configurations of connection terminals connected to the connection terminals of the storage battery modules M1 to M10, and the like are set for each type of the storage battery modules M1 to M10 to be connected. The connection terminals 117 of the wire harnesses WH2 for communication and power supply connected to the connection terminals 118 of the switch units SU1 to SU10 are standardized regardless of the types of the storage battery modules M1 to M10.

The wire harness unit 160 for communication and power supply includes a bundle portion 161 in which a plurality of wire harnesses for communication and wire harnesses for power supply are bundled, and branch lines 162, 163, 164, 165, and 166 in which the wire harnesses are branched from the bundle portion 161. The bundle portion 161 is wired on the connection units CU2 to CU6 so as to extend along the arrangement direction of the connection units CU2 to CU6. Abase end of the bundle portion 161 is connected to the BMS 150 (see FIG. 1).

The branch lines 162 and 163 are signal lines for transmitting a control signal of the switch S1. Accordingly, connection terminals 119 to which the branch lines 162 and 163 are connected are provided in the switch units SU1 to SU10.

The branch lines 164 and 165 are signal lines for transmitting a control signal of the switch S2. Accordingly, connection terminals 120 to which the branch lines 164 and 165 are connected are provided in the switch units SU1 to SU10.

The branch line 166 includes a signal line for performing communication with the storage battery modules M1 to M10 and a power line for supplying power from a BMS 150 side to a communication circuit (not shown) in the storage battery modules M1 to M10. Accordingly, the switch units SU1 to SU10 are provided with connection terminals 118 to which the branch lines 166 and the wire harnesses WH2 for communication and power supply are connected. Power is supplied from an upper power source to the BMS 150, the power converter 130, and electrical components such as the communication circuits in the storage battery modules M1 to M10. The power may be supplied from the upper power source to the communication circuits in the storage battery modules M1 to M10 without passing through the BMS 150.

The switch units SU1 to SU10 each include the power line (not shown) and the switches S1 and S2. The power line overlaps the bypass line BL (see FIG. 3 and the like) provided on the plate 110 via an insulating layer. The switch S1 is connected to the bypass line BL, and the switch S2 is connected to the power line.

When the switch units SU1 to SU10 are mounted on the plate 110, the power line on a switch units SU1 to SU10 side and the bypass line BL on the plate 110 side are connected. Further, the power lines of the switch units SU1 to SU10 adjacent to each other are connected by the bus bar 104.

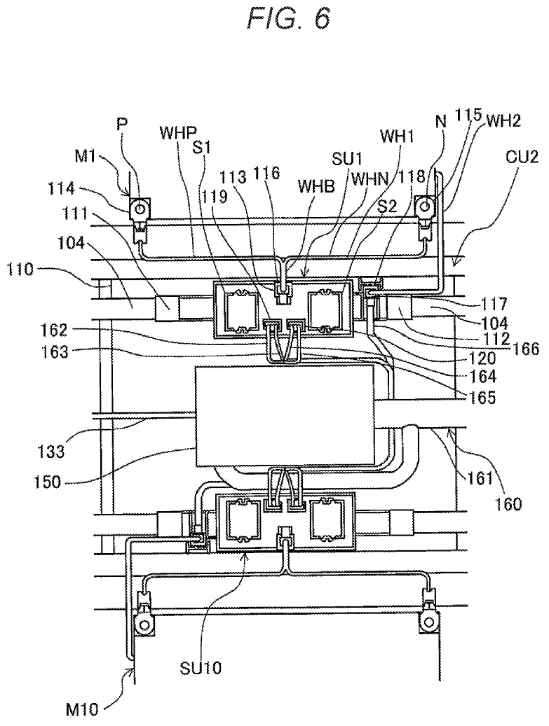

FIG. 6 is a plan view showing the connection unit CU2 shown in FIGS. 1 and 2. As shown in this drawing, the connection unit CU2 disposed between the storage battery modules M1 and M10 is provided with the BMS 150. The bundle portion 161 of the wire harness unit 160 for communication and power supply is connected to this BMS 150. The BMS 150 and the power converter 130 (see FIG. 1) are connected by a wire harness 133 for communication. The BMS 150 may be provided in other connection units CU1 and CU3 to CU6.

The configuration of the connection unit CU2 is common to those of the connection units CU3 to CU5 except that the BMS 150 is mounted on the plate 110. The connection unit CU2 is manufactured by mounting the BMS 150 on the connection units CU3 to CU5.

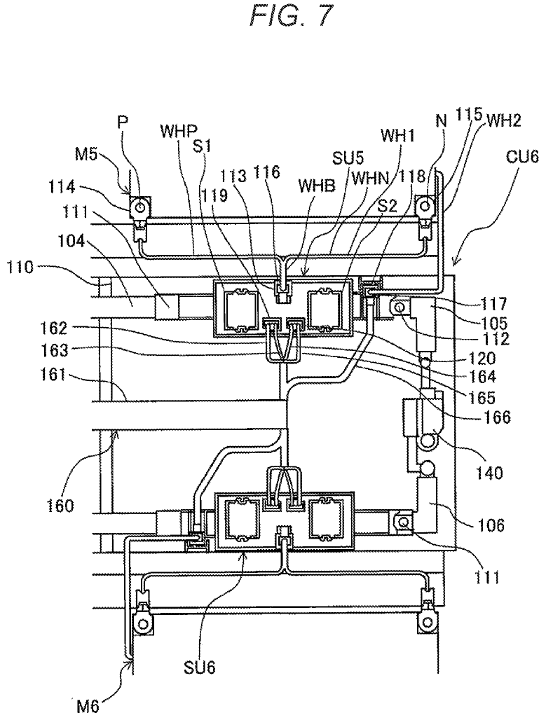

FIG. 7 is a plan view showing the connection unit CU6 shown in FIGS. 1 and 2. As shown in this drawing, the service plug 140 is provided in the connection unit CU6 disposed between the storage battery modules M5 and M6. This service plug 140 and the output terminal 112 of the switch unit SU5 are electrically connected by the bus bar 105, and the service plug 140 and the input terminal 111 of the switch unit SU6 are electrically connected by the bus bar 106.

The configuration of the connection unit CU6 is common to those of the connection units CU3 to CU5 except that the service plug 140 and the bus bars 105 and 106 are mounted on the plate 110. The connection unit CU6 is manufactured by mounting the service plug 140 and the bus bars 105 and 106 on the connection units CU3 to CU5.

As described above, in the storage battery connection module 100 according to the present embodiment, the base plate 101, the plurality of connection terminals 113, the power line such as the bus bar 104, and the plurality of wire harnesses WH1 for power supply are modularized. The plurality of connection terminals 113 are provided corresponding to the respective storage battery modules M1 to M10, the power line such as the bus bar 104 connects the plurality of connection terminals 113 in series, and the plurality of wire harnesses WH1 for power supply each connect the positive electrode terminal P and the negative electrode terminal N of each of the storage battery modules M1 to M10 to the connection terminal 113.

Here, in an assembly step of connecting the plurality of storage battery modules M1 to M10, before a start of the assembly step, the power line such as the bus bar 104 is already wired on the base plate 101, and the plurality of connection terminals 113 are also mounted on the base plate 101. Therefore, in the assembly step, the plurality of storage battery modules M1 to M10 can be connected in series by simple work of connecting the connection terminals 114 and 115 of the wire harnesses WH1 for power supply wired corresponding to the respective storage battery modules M1 to M10 to the positive electrode terminals P or the negative electrode terminals N. Accordingly, in the assembly step, it is possible to prevent an increase in the number of steps and complicated work. In addition, since it is possible to reduce work errors in the assembly step and prevent complication of the wiring, it is possible to reduce a risk of failure of the power storage system 1 and reduce a maintenance cost of the power storage system 1.

Further, in the power storage system 1 according to the present embodiment, while the storage battery modules M1 to M10 are recycled, the wire harness WH1 for power supply is a dedicated product which is exclusively manufactured for each type of the storage battery modules M1 to M10. Here, for example, when in-vehicle storage battery modules are recycled and used, the positions, sizes, and shapes of the positive electrode terminal P and the negative electrode terminal N are different for each vehicle type, and a voltage is also different for each vehicle type. Accordingly, in the storage battery connection module 100 according to the present embodiment, the wire harness WH1 for power supply is a dedicated product for each type of storage battery modules for each vehicle type or the like. Accordingly, according to the storage battery connection module 100 of the present embodiment, the plurality of storage battery modules M1 to M10 can be connected in series regardless of the type of the storage battery modules M1 to M10 to be recycled.

Further, in the storage battery connection module 100 according to the present embodiment, the base plate 101 is constituted by a plurality of insulating plates 110 which are integrated. Accordingly, a component cost of the base plate 101 can be reduced as compared with a case where the base plate 101 is formed of one single long plate. Here, the connection units CU2 to CU6 in which the plate 110 and the connection terminals 113 are provided include units having a common structure, and are common products having a common configuration in part or all. Accordingly, by increasing or decreasing the number of units having the common structure, it is possible to easily cope with an increase or decrease in the number of connections of the storage battery modules M1 to M10, and to improve versatility. In addition, by adding necessary components to the units having the common structure of the connection units CU2 to CU6, it is possible to flexibly cope with a change in the configuration of the storage battery connection module 100 such as presence or absence of the current sensor 108, the service plug 140, or the BMS 150.

Further, in the storage battery connection module 100 according to the present embodiment, the bypass line BL, the switch S1 for blocking or conducting the bypass line BL, and the switch S2 for blocking or conducting the power line are provided corresponding to each of the storage battery modules M1 to M10. Therefore, in the power storage system 1, the number of wirings and the number of connection points of wirings are increased. Accordingly, in the storage battery connection module 100 according to the present embodiment, the wire harness unit 160 for communication and power supply for transmitting control signals to the switches S1 and S2 is wired on the base plate 101. Accordingly, in the assembly step of communicably connecting the plurality of storage battery modules M1 to M10, wiring work and wiring connection work of the wire harness unit 160 for communication and power supply are not necessary, and in the assembly step, it is possible to prevent an increase in the number of steps and the complicated work.

In the storage battery connection module 100 according to the present embodiment, the switch units SU1 to SU10 each including the switches S1 and S2 are provided corresponding to the respective storage battery modules M1 to M10. Here, it is possible to select mounting or non-mounting of the switch units SU1 to SU10 on the plate 110 using the common connection units CU2 to CU6. Accordingly, it is possible to easily and flexibly cope with the increase or decrease in the number of connections of the storage battery modules M1 to M10, and to improve the versatility.

Further, when the switch units SU1 to SU10 are not mounted, the jumpers JP can be attached to positions of the switch units SU1 to SU10 on the plate 110, and the bus bars (104 and the like) on a plate 110 side can be connected by the jumpers JP. Accordingly, it is possible to easily and flexibly cope with the increase or decrease in the number of connections of the storage battery modules M1 to M10, and to improve the versatility. When the switch units SU1 to SU10 to which the storage battery modules M1 to M10 are not connected are mounted, it is necessary to turn on the switches S1 and turn off the switches S2 of the switch units SU1 to SU10, and it is necessary to energize the switches S1 and S2. Accordingly, power saving can be implemented by making the jumpers JP conduct the power line without mounting the switch units SU1 to SU10.

On the other hand, it is possible to select mounting or non-mounting of the switches S1 and S2 on the switch units SU1 to SU10. Here, when the switches S1 are not mounted on the switch units SU1 to SU10, the jumpers (not shown) can be attached to the positions of the switches S1 on the switch units SU1 to SU10, and the bypass line BL can be connected by the jumper. In addition, when the switches S2 are not mounted on the switch units SU1 to SU10, the jumpers (not shown) can be attached to the positions of the switches S2 and positions of the connection terminals 113 on the switch units SU1 to SU10 to connect the power lines on the switch units SU1 to SU10. Accordingly, the number of connections of the storage battery modules M1 to M10 to the connection units CU1 to CU10 can be 1 or 0.

In addition, when the switch units SU1 to SU10 are not mounted, the switch units SU1 to SU10 can be replaced with jumper units (not shown) having a structure for connecting the storage battery modules M1 to M10 to the bus bars (104 and the like) on the plate 110 without including the bypass circuit. Alternatively, when the switch units SU1 to SU10 are not mounted, the connection terminal (not shown) can be provided in place of the connection terminal 113, and the jumper (not shown) can be attached between the connection terminal and the bus bar (104 or the like) on the plate 110 to connect the connection terminal and the bus bar (104 or the like). Accordingly, when a bypass function is not necessary, the storage battery modules M1 to M10 can be connected without the bypass function.

In addition, when the switches S2 are not mounted on the switch units SU1 to SU10, the jumpers (not shown) can be attached to the positions of the switches S2 on the switch units SU1 to SU10 to connect the power lines on the switch units SU1 to SU10. Accordingly, when a bypass function is not necessary, the storage battery modules M1 to M10 can be connected without the bypass function.

Further, the switch units SU1 to SU10 include the connection terminals 119 and 120 to which branch lines 162 to 165 for transmitting the control signals for controlling the switches S1 and S2 are connected. Accordingly, the selection of mounting/non-mounting of the switch units SU1 to SU10 and the selection of mounting/non-mounting of the connection terminals 119 and 120 can be performed together.

The storage battery connection module 100 according to the present embodiment includes the plurality of connection terminals 118 and the plurality of wire harnesses WH2 for communication and power supply. The wire harness WH2 for communication and power supply connects connection terminals for communication and power supply provided in the storage battery modules M1 to M10 to the connection terminals 118. In the assembly step of connecting the plurality of storage battery modules M1 to M10, before the start of the assembly step, the plurality of connection terminals 118 are already mounted on the base plate 101, and the wire harness WH2 for communication and power supply is also wired in the storage battery connection module 100. Therefore, in the assembly step, the plurality of storage battery modules M1 to M10 can be communicably connected by simple work of connecting the connection terminals of the wire harnesses WH2 for communication and power supply wired corresponding to the respective battery modules M1 to M10 to the connection terminals for communication and power supply of the storage battery modules M1 to M10. Accordingly, in the assembly step, it is possible to prevent an increase in the number of steps and complicated work.

Further, in the storage battery connection module 100 according to the present embodiment, the wire harness WH2 for communication and power supply is a dedicated product which is exclusively manufactured for each type of the recycled storage battery modules M1 to M10. Here, for example, when the in-vehicle storage battery modules are recycled, the positions, sizes, and shapes of connection terminals for communication and power supply and the number, positions, thicknesses, and the like of the pins are different for each vehicle type. Further, types of information output from the storage battery modules M1 to M10 are different for each vehicle type. Accordingly, in the storage battery connection module 100 according to the present embodiment, the wire harness WH2 for communication and power supply is a dedicated product for each type of storage battery module for each vehicle type or the like. Accordingly, according to the storage battery connection module 100 of the present embodiment, the plurality of storage battery modules M1 to M10 can be communicably connected regardless of the type of the storage battery modules M1 to M10 to be recycled.

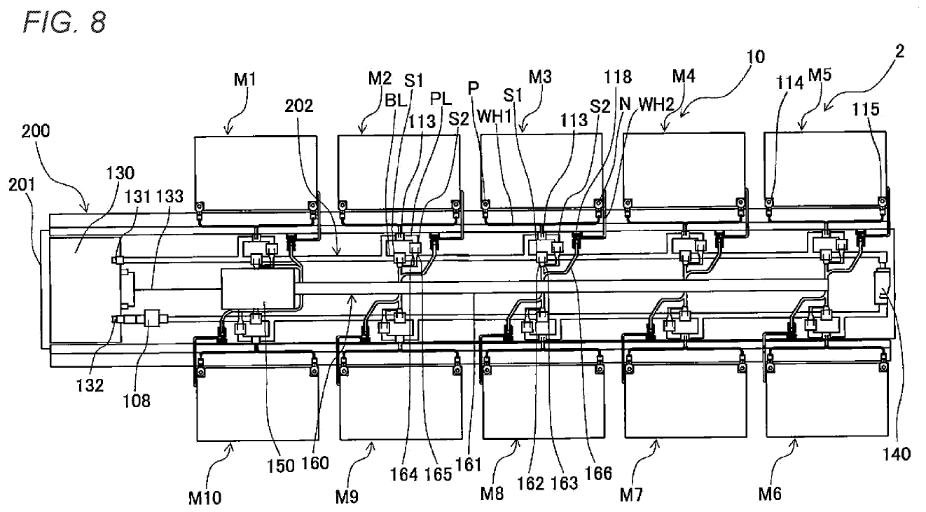

FIG. 8 is a plan view showing the power storage system 2 including a storage battery connection module 200 according to another embodiment of the present invention. As shown in this drawing, the power storage system 2 according to the present embodiment includes the storage battery string 10 and the storage battery connection module 200. The same components as those of the above-described embodiment are denoted by the same reference numerals, and the description of the above-described embodiment is incorporated.

The storage battery connection module 200 includes a base plate 201, a power line 202, the same number of switches S1 and S2 as the storage battery modules M1 to M10, the current sensor 108, the power converter 130, the service plug 140, and the BMS 150. The storage battery connection module 200 further includes the wire harness unit 160 for communication and power supply, the wire harnesses WH1 for power supply, and the wire harnesses WH2 for communication and power supply. Further, the storage battery connection module 200 includes the same number of connection terminals 113 and 118 as the storage battery modules M1 to M10.

The base plate 201 is formed of one single long insulating plate. The power line 202 is provided on the base plate 201. The power line 202 includes a plurality of conductors such as bus bars for passing a large amount of current. The conductor is the bus bar in the present embodiment.

The power line 202 connects the plurality of storage battery modules M1 to M10 in series. The power line 202 includes a U-shaped main power line PL and the bypass line BL for each of the storage battery modules M1 to M10. The bypass line BL connects both ends of the main power line PL.

The main power line PL is provided with the connection terminal 113 and the switch S2. The bypass line BL is provided with the switch S1. The wire harness WH1 for power supply is connected to the connection terminal 113, and the branch lines 164 and 165 are connected to the switch S2. The branch lines 162 and 163 are connected to the switch S1. Similarly to the above-described embodiment, the switch units SU1 to SU10 may be mounted.

The connection terminal 118 is mounted on the base plate 201 for each of the storage battery modules M1 to M10. The wire harness WH2 for communication and power supply and the branch line 166 are connected to the connection terminal 118.

Also in the power storage system 2 according to the present embodiment, the wire harness WH1 for power supply is a dedicated product provided for each type of the storage battery modules M1 to M10 to be connected. That is, configurations of the connection terminals 114 and 115 of the wire harness WH1 for power supply, a length and a thickness of the wire harness WH1 for power supply, and the like are set for each type of the storage battery modules M1 to M10 to be connected.

Also in the power storage system 2 according to the present embodiment, the wire harness WH2 for communication and power supply is a dedicated product provided for each type of the storage battery modules M1 to M10 to be connected. That is, a length and a thickness of the wire harness WH2 for communication and power supply, configurations of connection terminals, and the like are set for each type of the storage battery modules M1 to M10 to be connected.

As described above, the storage battery connection module 200 according to the present embodiment has the same configuration as the storage battery connection module 100 according to the above-described embodiment except that the base plate 201 is formed of a single long plate. Thus, according to the storage battery connection module 200 of the present embodiment, same effects as those of the above-described embodiment can be obtained.

Although the present invention is described above based on the above-described embodiment, the present invention is not limited to the above-described embodiment, modifications may be made without departing from the gist of the present invention, and publicly known or well-known techniques may be appropriately combined.

For example, in the above-described embodiment, the storage battery connection modules 100 and 200 include the power converter 130, the service plug 140, the BMS 150, and the wire harness unit 160 for communication and power supply, but it is not essential that the storage battery connection modules 100 and 200 include these components.

In the above-described embodiment, the storage battery connection modules 100 and 200 include the bypass line BL and the switches S1 and S2, but it is not essential that the storage battery connection modules 100 and 200 include these components. For example, in a case where deterioration states of the storage battery modules M1 to M10 are uniform, the bypass line BL and the switches S1 and S2 may not be provided.

What is claimed is:

1. A storage battery connection module in which a plurality of storage batteries are connected in series, the storage battery connection module comprising:
a base plate constituted by a plurality of insulating plates which are integrated or one long insulating plate;
a plurality of first connection terminals provided on the base plate;
a plurality of first power lines each connecting the first connection terminal to a positive electrode terminal and a negative electrode terminal of the storage battery; and
a second power line provided on the base plate and connecting the plurality of first connection terminals in series.

2. The storage battery connection module according to claim 1, wherein
the storage battery is recycled, and
the first power line is a dedicated product which is exclusively manufactured for each type of the storage battery.

3. The storage battery connection module according to claim 1, wherein
the base plate is constituted by a plurality of insulating plates which are integrated,
the plate of the base plate is provided with the first connection terminal,
the storage battery connection module includes a plurality of connection units each including the plate of the base plate and the first connection terminal, and
the plurality of connection units are common products having a common structure.

4. The storage battery connection module according to claim 1, further comprising:
a plurality of bypass lines each provided on the base plate and bypassing the first connection terminal;
a plurality of first switches each provided on the bypass line and configured to block or conduct the bypass line;
a plurality of second switches each provided on the second power line and configured to block or conduct the second power line; and
a first signal line configured to transmit a control signal for controlling the first switch and the second switch and wired on the base plate.

5. The storage battery connection module according to claim 4, further comprising:
a plurality of switch units each of which is mounted on the base plate and includes the first switch, the second switch, the bypass line, and the first connection terminal.

6. The storage battery connection module according to claim 5, wherein
mounting and non-mounting of the switch unit on the base plate or mounting and non-mounting of at least one of the first switch and the second switch on the switch unit is selectable,
when the switch unit is not mounted on the base plate, the second power line is connected by a jumper,
when the first switch is not mounted on the switch unit, the bypass line is connected by jumper, and
when the second switch is not mounted on the switch unit, the second power line is connected by a jumper.

7. The storage battery connection module according to claim 5, wherein
mounting and non-mounting of the switch unit on the base plate or mounting and non-mounting of at least one of the first switch and the second switch on the switch unit is selectable,
when the switch unit is not mounted on the base plate, the first power line and the second power line are connected by a jumper, and
when the second switch is not mounted on the switch unit, the first power line and the second power line are connected by a jumper.

8. The storage battery connection module according to claim 5, wherein
the switch unit includes a second connection terminal to which the first signal line is connected.

9. The storage battery connection module according to claim 1, further comprising:
a plurality of third connection terminals; and
a plurality of second signal lines each connecting a connection terminal for communication provided in the storage battery and the third connection terminal.

10. The storage battery connection module according to claim 9, wherein
the storage battery is recycled, and
the second signal line is a dedicated product which is exclusively manufactured for each type of the storage battery.

11. The storage battery connection module according to claim 9, further comprising:
a plurality of bypass lines each provided on the base plate and bypassing the first connection terminal;
a plurality of first switches each provided on the bypass line and configured to block or conduct the bypass line;
a plurality of second switches each provided on the second power line and configured to block or conduct the second power line;
a first signal line configured to transmit a control signal for controlling the first switch and the second switch and wired on the base plate;
a control device configured to output the control signal transmitted through the first signal line;
a plurality of third power lines each connecting a connection terminal for power supply provided in the storage battery and the third connection terminal; and
a fourth power line connecting the plurality of third connection terminals and the control device.

12. A wire harness used in a storage battery connection module in which a plurality of recycled storage batteries are connected in series, wherein
the storage battery connection module includes
a base plate constituted by a plurality of insulating plates which are integrated or one long insulating plate,
a plurality of connection terminals provided on the base plate, and
a power line provided on the base plate and connecting the plurality of connection terminals in series,
the wire harness connects the connection terminal to a positive electrode terminal and a negative electrode terminal of the storage battery, and
the wire harness is a dedicated product which is exclusively manufactured for each type of the storage battery.

13. A power storage system comprising:
a plurality of storage batteries; and
a storage battery connection module in which the plurality of storage batteries are connected in series, wherein
the storage battery connection module includes
a base plate constituted by a plurality of insulating plates which are integrated or one long insulating plate,
a plurality of connection terminals provided on the base plate,
a plurality of first power lines each connecting the connection terminal to a positive electrode terminal and a negative electrode terminal of the storage battery, and
a second power line provided on the base plate and connecting the plurality of connection terminals in series.
